(19) United States
(12) Patent Application Publication
(10) Pub. No.: US 2012/0300129 A1
(43) Pub. Date: Nov. 29, 2012

(54) SYSTEM AND METHOD FOR CONTROLLING AUDIO/VIDEO DATA STREAMS

(76) Inventors: Theodore S. Hetke, Hillsboro, OR (US); Randolph W. Nash, McMinnville, OR (US); Frank Prestrelski, Portland, OR (US); Raj K. Garg, Portland, OR (US)

(21) Appl. No.: 13/115,007

(22) Filed: May 24, 2011

(51) Int. Cl. H04N 5/268

(52) U.S. Cl. 348/705; 348/E05.057

(57) ABSTRACT

An apparatus and method processes audio/video (AV) streams in an intelligent manner by determining whether at least one AV source and/or destination is coupled to an AV dongle that is coupled to a host-type device. An indication is provided to the host-type device to process an AV stream as if the AV dongle is not coupled to the host-type device if it is determined that the at least AV source and/or destination is not coupled to an AV dongle and if the AV dongle is coupled to a host-type device. If it is determined that at least one AV source and/or destination is coupled to the AV dongle, selecting a driver and selecting a priority table contained in the AV dongle for processing the AV stream based on priority information contained in the priority table.

### BACKGROUND

When a conventional audio/video-type (CAV-type) dongle is plugged into a Universal Serial Bus (USB) port of a host computer device and there is no AV source or destination device connected to the dongle, the host computer device responds by directing the AV streams through the CAV-type dongle even though no devices are connected to the CAV-type dongle. Additionally, when an AV source or destination device becomes disconnected from a CAV-type dongle, a host computer device continues to direct AV streams through the CAV-type dongle even though no devices are connected to the CAV-type dongle. The foregoing default behavior can be modified by user intervention into another set of behaviors, such as ignoring that a CAV-type dongle has been plugged in to the USB port of a host computer device.

### BRIEF DESCRIPTION OF THE DRAWINGS

The subject matter disclosed herein is illustrated by way of example and not by limitation in the accompanying figures in which like reference numerals indicate similar elements and in which:

FIG. 1 depicts a functional block diagram of an Audio Sense AV-type (ASAV-type) dongle according to the subject matter disclosed herein;

FIG. 2 depicts a state diagram for processing an A/V source/stream by a CAV-type dongle; and

FIG. 3 depicts a state diagram for processing an A/V source/stream by an ASAV-type dongle according to the subject matter disclosed herein.

### DETAILED DESCRIPTION

As used herein, the word “exemplary” means “serving as an example, instance, or illustration.” Any embodiment described herein as “exemplary” is not to be construed as necessarily preferred or advantageous over other embodiments. Additionally, in the following description and/or claims, the terms “coupled” and/or “connected,” along with their derivatives, may be used. In particular embodiments, connected may be used to indicate that two or more elements are in direct physical and/or electrical contact with each other. “Coupled” may, however, also mean that two or more elements may not be in direct contact with each other, but yet may still cooperate and/or interact with each other through a wireless connection, such as, but not limited to a radio-frequency and/or optical link. Further, it will be appreciated that for simplicity and/or clarity of illustration, elements illustrated in the figures have not necessarily been drawn to scale. For example, the dimensions of some of the elements may be exaggerated relative to other elements for illustrative clarity. Further, in some figures only one or two of a plurality of similar elements indicated by reference characters for illustrative clarity of the figure, whereas all of the similar element may not be indicated by reference characters. Further still, it should be understood that although some portions of components and/or elements of the subject matter disclosed herein have been omitted from the figures for illustrative clarity, good engineering, construction and assembly practices are intended.

As used herein, the term “AV” refers to one or more audio streams, one or more video streams, one or more voice streams, or a combination of one or more audio, one or more video streams and/or one or more voice streams. As used herein, the terms “conventional AV (CAV) dongle” and “CAV-type dongle” mean a USB-type dongle-type device that is capable of being plugged into a host-type device and that is capable of inputting and/or outputting, wired and/or wirelessly, one or more audio streams and/or one or more video streams between the host-type device and another device connected to the CAV-type dongle, such as, but not limited to a pair of headphones, one or more speakers, a video display system, an audio/video processing device, a microphone, an audio source, a video source and/or an audio/video source.

As used herein, the terms “host device” or “host-type device” mean a system or device that is capable of providing host functionality, such as, but not limited to a desktop computer, a laptop computer, a cellular telephone, a smart phone, a television, a gaming device, a tablet-type device, an eReader-type device, or an ePad-type device. As used herein, the terms “USB” or “USB-type” refer to compatibility with the Universal Serial Bus Specification.

As used herein, the terms “audio-sense audio/video” (ASAV) dongle and an ASAV-type dongle, mean a USB-type dongle-type device that is capable being plugged into a host-type device and that is capable of inputting and/or outputting, wired and/or wirelessly, according to the subject matter disclosed herein one or more audio stream, one or more video streams and/or one or more voice streams between the host-type device and another device connected to the ASAV-type dongle, such as, but not limited to a pair of headphones, one or more speakers, a video display system, an audio/video processing device, a microphone, an audio source, a video source, an audio/video source and/or a voice source. An ASAV-type dongle differs from a CAV-type dongle by being capable of processing one or more AV streams according to the subject matter disclosed herein, whereas a CAV-type dongle does not process the one or more AV streams according to the subject matter disclosed herein. It should be understood that the functionality of an ASAV-type dongle as disclosed herein is not limited to a dongle-type device arrangement, but could alternatively be embodied as embedded in a host-type device.

In a situation in which an ASAV-type dongle is plugged into the host-type device, but no AV source or destination devices are connected to the ASAV-type dongle, the subject matter disclosed herein provides that a host-type device responds as if no dongle has been plugged in. Thus, the host-type processes an AV stream as if no dongle was plugged into the host-type device. In contrast, when a CAV-type dongle is plugged into the host-type device, and no devices are connected to the CAV-type dongle, the host-type device responds as if the CAV-type dongle is plugged in and AV streams are directed through the CAV-type dongle even though no AV source or destination devices are connected to the CAV-type dongle.

The subject matter disclosed herein also provides that in a situation in which a device becomes disconnected from the ASAV-type dongle, the one or more AV streams that were directed to/from the disconnected device are redirected to other devices connected to the ASAV-type dongle based on a user-configurable priority scheme. In contrast, in a situation in which a device becomes disconnected from a CAV-type dongle, AV streams are directed through the CAV-type dongle even though no devices are connected to the CAV-type dongle.

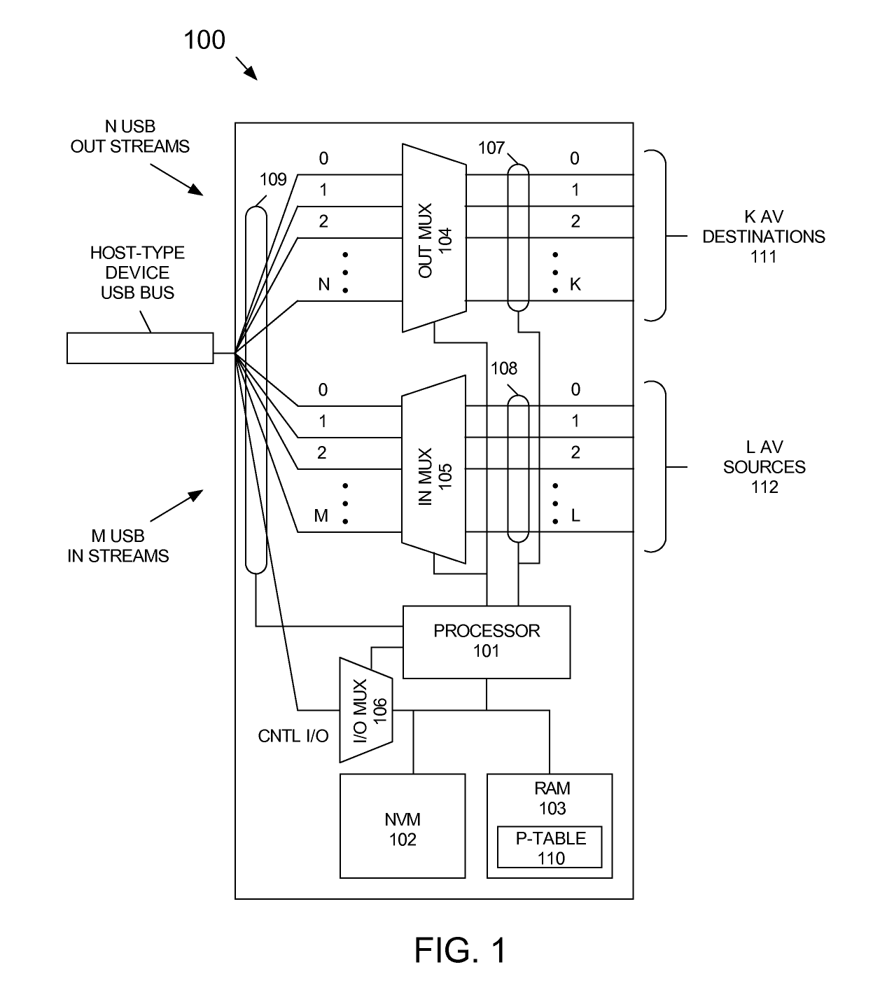

FIG. 1 depicts a functional block diagram of an Audio Sense AV-type (ASAV-type) dongle 100 according to the subject matter disclosed herein. ASAV-type dongle 100 comprises a processor 101, a Non-Volatile Memory (NVM) 102, a Random-Access Memory (RAM) 103, an output multiplexer (OUT MUX) 104, an input multiplexer (IN MUX) 105, a Control I/O multiplexer (I/O MUX) 106 and signal sensors 107-109. In one exemplary embodiment, processor 101 is operatively coupled in a well-known manner to NVM 102, RAM 103 and signal sensors 107-109 to provide signal sensing and signal processing capability to control OUT MUX 104, IN MUX 105 and I/O MUX 106 as disclosed herein. OUT MUX 104 is coupled to a USB bus, which is part of a host-type device (not shown), and multiplexes N audio/video (AV) output streams to K audio/video (AV) streams at that are directed to K audio/video (AV) destinations at 111 under input control signals generated by processor 101. Similarly, IN MUX 105 is coupled to the USB bus of a host-type device (not shown) and multiplexes L audio/video (AV) source streams from L audio/video (AV) sources at 112 to M audio/video (A/V) input streams under output control signals generated by processor 101. In one exemplary embodiment, OUT MUX 104 and/or IN MUX 105 are coupled to the USB bus, AV destinations and/or AV sources through a direct electrical connection, such as, but not limited to, a USB-type connector. In another exemplary embodiment OUT MUX 104 and/or IN MUX 105 are coupled to the USB bus, AV destinations and/or AV sources through a wireless connection, such as, but not limited to, a radio-frequency (RF) link and/or an optical link.

NVM 102 operatively stores instructions and information that are executed and used by processor 101 in a well-known manner for signal sensing and signal processing capability to control OUT MUX 104, IN MUX 105 and I/O MUX 106 as disclosed herein. RAM 103 is operatively used by processor 101 in a well-known manner to temporarily store instructions and information for signal sensing and processing capability to control OUT MUX 104, IN MUX 105 and I/O MUX 106 as disclosed herein. In one exemplary embodiment, RAM 103 stores a Priority Table (P-Table) 110 that is accessed by processor 101 for determining appropriate system states and responses based on received inputs and sensed signal conditions. Exemplary inputs that are received by and exemplary signal conditions experienced by ASAV-type dongle 100 include, but are not limited to, N output states, M input states, host requests, protocol interactions, user inputs and device inputs. In response to such exemplary inputs and conditions, ASAV-type dongle 100 generates system states that include, but are not limited to, corresponding N new output states, M new input states, responses to host requests, responses and indications to user inputs and responses to device inputs.

In one exemplary embodiment, ASAV-type dongle 100 is formed from an Application Specific Integrated Circuit (ASIC). In another exemplary embodiment, ASAV-type dongle 100 is formed from a plurality of integrated circuits (ICs).

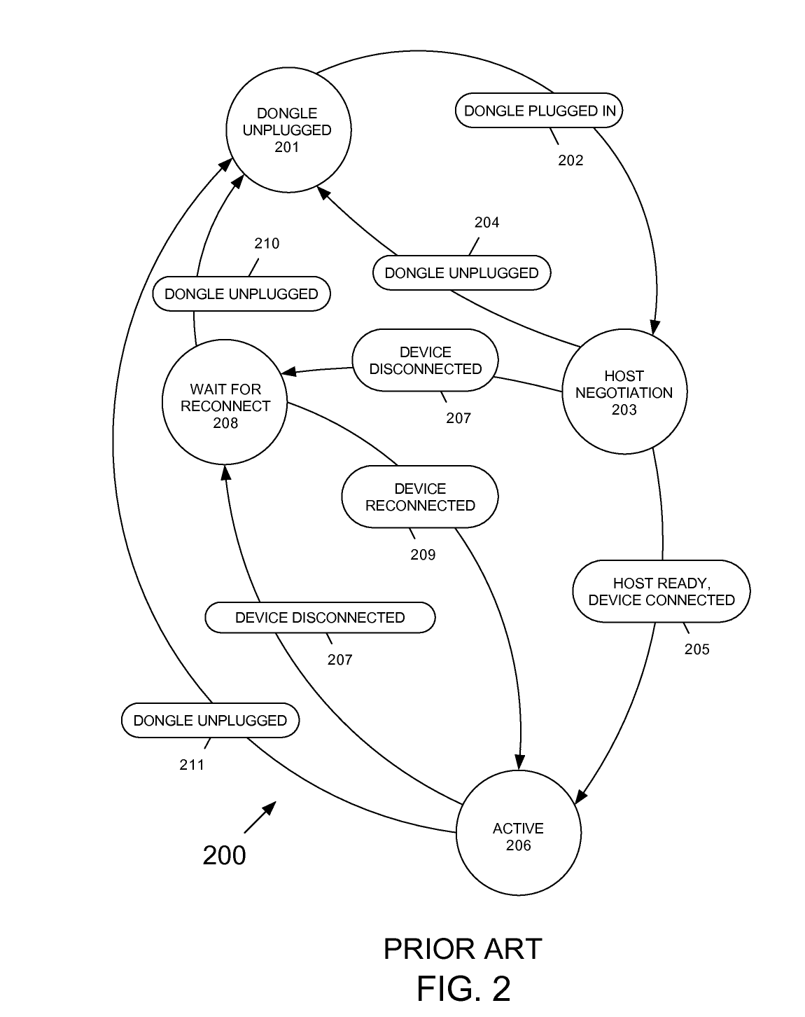

FIG. 2 depicts a state diagram 200 for processing an A/V source/stream by a CAV-type dongle. The initial system state, a Dongle Unplugged State 201, represents a system state that is completely controlled by a host-type device (not shown), such as, but not limited to, a desktop computer, a laptop computer, a cellular telephone, a smart phone, a television, a gaming device, a tablet-type device, an eReader-type device, or an ePad-type device. The host-type device runs an operating system that interfaces with a USB-type device and transfers control of an AV stream through the USB-type device to the USB-type device. The Dongle Unplugged State 201 is a system state in which a CAV-type dongle has not yet been plugged into a USB port of the host-type device. While in State 201, the host-type device processes any AV streams based on the current system state of the host-type device.

The system state remains at State 201 until at 202 a CAV-type dongle is plugged into a USB port of the host-type device, at which time the system state transitions from State 201 to State 203—Host Negotiation State 203—where the host-type device enumerates the CAV-type dongle and loads the appropriate driver for the source and/or destination (source/destination) device for which the CAV-type dongle has been configured. If the CAV-type dongle becomes unplugged at 204 while the system is at State 203, the system returns to State 201.

After the appropriate driver has been loaded at Host Negotiation State 203, at 205 the host-type device is ready and the source/destination device is connected to the CAV-type dongle. The system state transitions from State 203 to the Active State 206, where one or more AV streams are directed to/from the source/destination device connected to the CAV-type dongle under control of the appropriate driver for the device connected to the CAV-type dongle.

If, while the system state is in Active State 206, the source/destination device that was connected to the CAV-type dongle is disconnected at 207, the system state transitions to the Wait For Reconnect State 208. If a source/destination device is reconnected to the CAV-type dongle at 209, the system state transitions back to the Active State 206 and one or more AV streams are directed to/from source/destination device connected to the CAV-type dongle under control of the appropriate driver for the source/destination device connected to the CAV-type dongle. If no source/destination device is reconnected to the CAV-type dongle, the system state remains in the Wait For Reconnect State 208 because conventionally there is no time-out process. If, while the system is in the Wait For Reconnect State 208, the CAV-type dongle is unplugged at 210, the system state transitions to the Dongle Unplugged State 201. If, while the system is in Active State 206, the source/destination device that was connected to the CAV-type dongle is disconnected at 211, the system state transitions to the Dongle Unplugged State 201.

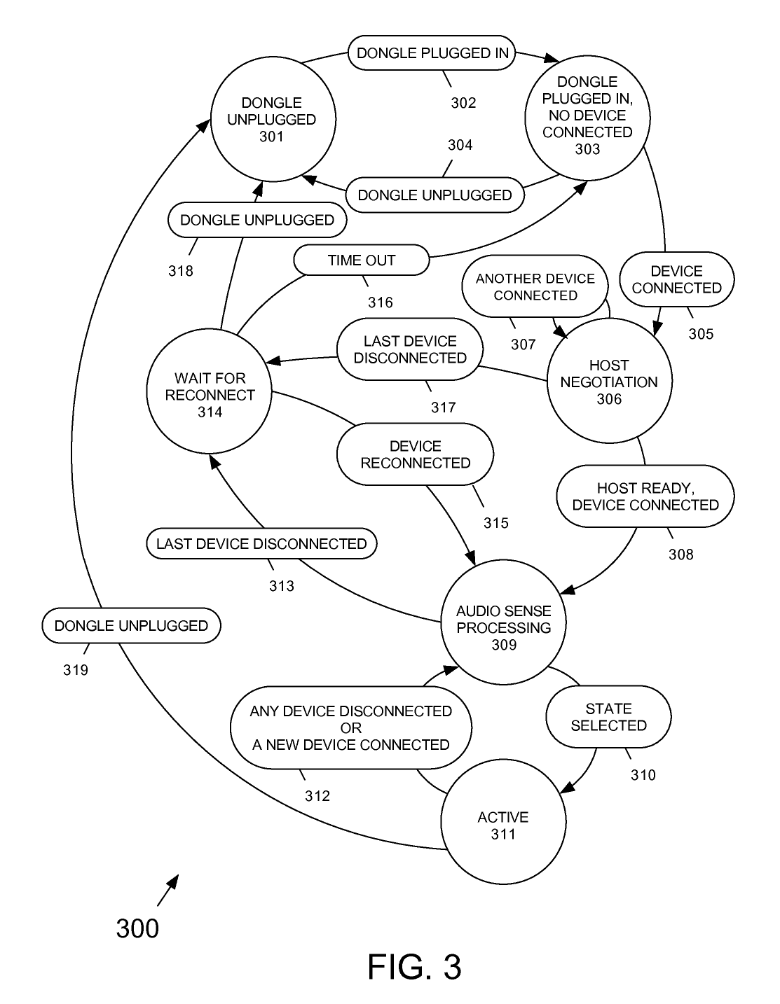

FIG. 3 depicts a state diagram 300 for processing an A/V source/stream by an ASAV-type dongle according to the subject matter disclosed herein. The initial state, a Dongle Unplugged State 301, represents a system state that is completely controlled by a host-type device (not shown), such as, but not limited to, a desktop computer, a laptop computer, a cellular telephone, a smart phone, a television, a gaming device, a tablet-type device, an eReader-type device, or an ePad-type device. The host-type device runs an operating system that interfaces with a USB-type device and transfers control of an AV stream through the USB-type device to the USB-type device. The Dongle Unplugged State 301 is a system state in which an ASAV-type dongle has not yet been plugged into a USB port of the host-type device. While in State 301, the host-type device processes any AV streams based on the current system state of the host-type device.

The system state remains at State 301 until at 302 an ASAV-type dongle is plugged into a USB port of the host-type device, at which time the system state transitions from State 301 to State 303—Dongle Plugged In, No Device Connected State. At State 303, if no source and/or destination (source/destination) device is connected to the ASAV-type dongle, the host-type device continues to process any AV streams based on the current system state of the host-type device as if the ASAV-type dongle was not plugged in. That is, the host-type continues to process any AV streams in a manner similar to how AV streams were processed in State 401. As used herein, the term “connected” also means “coupled,” such as in, but not limited to, wirelessly or optically coupled. ASAV-type dongle 100 determines via sensors 107-109 (FIG. 1) whether a source/destination device is connected to the ASAV-type dongle 100 by, but not limited to, the device communicating that it is “off,” a lack of signal, a “jack-sense” indication, a Signal to Noise Ratio (SNR) of a communication link between the ASAV-type device and a source/destination device, a Signal to Interference and Noise Ratio (SINR), a Bit Error Rate (BER), a Carrier Noise Ratio (CNR), a Received Signal Strength Indication (RSSI), a failed hand-shaking process, or a combination thereof.

If the ASAV-type dongle is unplugged at 304 while the system is at State 303, the system returns to State 301. When the system is in State 303, if at least one source/destination device is connected at 305 to the ASAV-type dongle, the system state transitions to Host Negotiation State 306, where the host-type device enumerates the ASAV-type dongle and selects and/or loads the appropriate driver and selects and/or configures the device priority table (P-Table 110) for the particular source/destination device connected to the ASAV-type dongle. In one exemplary embodiment, the driver may be loaded from the host-type device and/or the driver may be contained in non-volatile memory (NVM) 102. In another exemplary embodiment, P-Table 110 may exist in NWM 102. When more than one source/destination device is connected to the ASAV-type dongle, the appropriate drivers are loaded and device P-Table 110 is configured based on a defined priority associated with the source/destination devices connected to the ASAV-type dongle. If a new source/destination device is connected to the ASAV-type dongle at 307, the host-type device enumerates the ASAV-type dongle with the new source/destination device connected, the appropriate driver is loaded and device P-Table 110 is configured to reflect the overall device priority for the source/destination devices connected to the ASAV-type dongle. P-Table 110 contains information that defines a hierarchical priority for ASAV-type device for directing AV streams through the ASAV-type device. In an instance in which P-Table 110 contains a hierarchical priority for a source/destination device that is not currently connected, any processing of the AV stream(s) would be as if the source/destination device were not connected. In another exemplary embodiment, when the host-type device enumerates the ASAV-type dongle, an appropriate driver is selected from a plurality of available drivers and/or a P-Table is selected from a plurality of available P-Tables that corresponds to a default-type or user selected configuration of the ASAV-type dongle and the AV destination and/or AV sources present.

If, while at State 306, all source/destination devices connected to the ASAV-type dongle become disconnected—that is, the last source/destination device is disconnected from the ASAV-type dongle at 317—the system state transitions to the Wait For Reconnect State 314 and a time-out process begins waiting for a source/destination device to be reconnected to the ASAV-type dongle. ASAV-type dongle 100 determines via sensors 107-109 (FIG. 1) whether a source/destination device has become disconnected from the ASAV-type dongle 100 by, but not limited to, the source/destination device communicating that it is “off,” a lack of signal, a “jack-sense” indication, a Signal to Noise Ratio (SNR) of a communication link between the ASAV-type device and a source/destination device, a Signal to Interference and Noise Ratio (SINR), a Bit Error Rate (BER), a Carrier Noise Ratio (CNR), a Received Signal Strength Indication (RSSI), a failed hand-shaking process, or a combination thereof.

If a source/destination device is reconnected to the ASAV-type dongle at 315 and the host-type system is ready, the system state transitions to the Audio Sense Processing State 306 where the particular Active State for the reconnected source/destination device is selected. ASAV-type dongle 100 determines via sensors 107-109 (FIG. 1) whether a source/destination device has been reconnected to the ASAV-type dongle 100 by, but not limited to, the source/destination device communicating that it is “off,” a lack of signal, a “jack-sense” indication, a Signal to Noise Ratio (SNR) of a communication link between the ASAV-type device and a source/destination device, a Signal to Interference and Noise Ratio (SINR), a Bit Error Rate (BER), a Carrier Noise Ratio (CNR), a Received Signal Strength Indication (RSSI), a failed hand-shaking process, or a combination thereof. If no source/destination device is reconnected to the ASAV-type dongle before the time-out period expires at 316, the system state transitions from the Wait For Reconnect State 314 to the Dongle Plugged In, No Device Connected State 303. If, while in the Wait For Reconnect State 314, the ASAV-type dongle becomes unplugged at 318, the system state transitions to the Dongle Unplugged State 301.

After the appropriate driver(s) and priority table has been loaded and configured and/or selected at Host Negotiation State 306, and at 308 the host-type device is ready and at least one source/destination device is connected to the ASAV-type dongle, the system state transitions from State 306 to the Audio Sense Processing State 309 where, based on the configuration of device priority table 110, an appropriate Active State is selected at 310 and the system state transitions to the Active State 311. In Active State 311, one or more AV streams are directed to/from source/destination device(s) connected to the ASAV-type dongle under control of the device priority table 110 configuration and appropriate driver.

If, while the system is in Active State 311, a source/destination device that has been connected to the ASAV-type dongle is disconnected, a new device is connected or a user manually selects a different device at 312, the system state transitions back to the Audio Sense Processing State 309 where it is determined whether there is any remaining source/destination devices connected to the ASAV-type dongle. If there is at least one source/destination device still connected to the ASAV-type dongle, the appropriate new Active State for the device is selected at 310 (driver and/or priority from the P-Table) and the system state transitions to the Active State 311. Back in Active State 311, one or more AV streams are directed to/from source/destination device(s) connected to the ASAV-type dongle under control of the configuration of device priority table 110 and the appropriate driver.

If, while the system is in Active State 311, a new source/destination device is connected to the ASAV-type dongle, the system state transitions to the Audio Sense Processing State 409 where, based on the configuration of the device priority table, it can be determined whether a new Active State should be selected at 310. The system state then transitions to the Active State 311 based on the determination made at State 309. If, while in the Active State 311, the ASAV-type dongle becomes unplugged at 319, the system state transitions to the Dongle Unplugged State 301.

If, at State 309, there are no source/destination devices that are still connected to the ASAV-type dongle—that is, the last source/destination device is disconnected from the ASAV-type dongle at 313—the system state transitions to the Wait For Reconnect State 314 and a time-out process begins. If a source/destination device is reconnected to the ASAV-type dongle at 315, the system state transitions back to the Audio Sense Processing State 309 where the particular Active State is selected for the reconnected source/destination device. If no source/destination device is reconnected to the ASAV-type dongle before the time-out period expires at 316, the system state transitions from the Wait For Reconnect State 314 to the Dongle Plugged In, No Device Connected State 303.

In one exemplary embodiment, a user interface (not shown) is provided through the host-type device that a user can set and change the priority hierarchy for source/destination devices connected to the ASAV-type dongle. In an alternative exemplary embodiment, the priority hierarchy can be set at the factory, and is non-configurable by a user.

According to the subject matter disclosed herein, in a situation in which an ASAV-type dongle is plugged into the host-type device, but no source/destination devices are connected to the ASAV-type dongle, the host-type device responds as if no dongle has been plugged in. In contrast, in a situation in which a CAV-type dongle is plugged into the host-type device, and no source/destination devices are connected to the CAV-type dongle, the host-type device responds as if the CAV-type dongle has been plugged in and AV streams are directed through the CAV-type dongle as if a source/destination device is connected to the CAV-type dongle.

The subject matter disclosed herein also provides that in a situation in which a source/destination device becomes disconnected from the ASAV-type dongle, the one or more AV streams that were directed to/from the disconnected source/destination device are redirected to other source/destination devices connected to the ASAV-type dongle based on a user-configurable priority scheme. In contrast, in a situation in which a source/destination device becomes disconnected from a CAV-type dongle, AV streams are directed through the CAV-type dongle even though no source/destination devices are connected to the CAV-type dongle or the host-type device and CAV-type dongle remain in a state waiting for a reconnection of the disconnected source/destination device.

Although the foregoing disclosed subject matter has been described in some detail for purposes of clarity of understanding, it will be apparent that certain changes and modifications may be practiced that are within the scope of the appended claims. Accordingly, the present embodiments are to be considered as illustrative and not restrictive, and the subject matter disclosed herein is not to be limited to the details given herein, but may be modified within the scope and equivalents of the appended claims.

What is claimed is:

1. A method, comprising:
determining whether at least one audio/video (AV) source, at least one AV destination, or a combination thereof, is coupled to an AV dongle that is coupled to a host-type device; and
indicating to the host-type device to process an AV stream as if the AV dongle is not coupled to the host-type device if it is determined that the at least one AV source, the at least one AV destination or a combination thereof, is not coupled to the AV dongle, the AV stream comprising at least one audio stream, at least one video stream, at least one voice stream, or a combination thereof.

2. The method according to claim 1, further comprising:
selecting a driver for the AV stream if it is determined that at least one AV source, at least one AV destination, or a combination thereof, is coupled to the AV dongle;
selecting a priority table if it is determined that at least one AV source, at least one AV destination, or a combination thereof, is coupled to an AV dongle; and
processing the AV stream through the AV dongle based on priority information contained in the priority table, the priority information indicating a priority hierarchy of AV sources, AV destinations, or a combination thereof, for the AV stream.

3. The method according to claim 2, wherein determining whether an AV source, an AV destination, or a combination thereof, has become uncoupled from the AV dongle while the AV dongle is processing the AV stream; and
determining an alternative AV source, AV destination, or a combination thereof, for the AV stream based on priority information contained in the priority table.

4. The method according to claim 3, wherein the AV dongle is connectably coupled to the host-type device.

5. The method according to claim 3, wherein the AV dongle is wirelessly coupled to the host device.

6. The method according to claim 3, wherein at least one audio/video (AV) source, at least one AV destination, or a combination thereof, is connectably coupled to the AV dongle.

7. The method according to claim 3, wherein at least one audio/video (AV) source, at least one AV destination, or a combination thereof, is wirelessly coupled to the AV dongle.

8. The method according to claim 3, wherein the AV dongle is embedded as part of the host-type device.

9. The method according to claim 3, wherein the host-type device comprises a desktop computer, a laptop computer, a cellular telephone, a smart phone, a television, a gaming device, a tablet-type device, an eReader-type device, or an ePad-type device.

10. An article comprising: a non-transitory computer-readable medium having stored thereon instructions that, if executed, result in at least the following:
determining whether at least one audio/video (AV) source, at least one AV destination, or a combination thereof, is coupled to an AV dongle that is coupled to a host-type device; and
indicating to the host-type device to process an AV stream as if the AV dongle is not coupled to the host-type device if it is determined that the at least one AV source, the at least one AV destination or a combination thereof, is not coupled to the AV dongle, the AV stream comprising at least one audio stream, at least one video stream, at least one voice stream, or a combination thereof.

11. The article according to claim 10, further comprising:
selecting a driver for the AV stream if it is determined that the at least one AV source, the at least one AV destination, or a combination thereof, is not coupled to an AV dongle and if the AV dongle is coupled to a host-type device;
selecting a priority table contained in the AV dongle if it is determined that at least one AV source, at least one AV destination, or a combination thereof, is coupled to the AV dongle; and
processing the AV stream based on priority information contained in the priority table, the priority information indicating a hierarchy priority of AV sources, AV destinations, or a combination thereof, for the AV stream.

12. The article according to claim 11, wherein determining whether an AV source, an AV destination, or a combination thereof, has become uncoupled from the AV dongle while the AV dongle is processing the AV stream; and
determining an alternative AV source, AV destination, or combination thereof, for the AV stream based on priority information contained in the priority table.

13. An apparatus, comprising:
a signal path capable of being coupled between at least one audio/video (AV) source, at least one AV destination, or a combination thereof, and a host-type device; and
a processor capable of determining whether the at least one AV source, the at least one AV destination, or a combination thereof, is coupled between the AV signal path and the host-type device, the processor further capable of indicating to the host-type device to process an AV stream as if the processing device is not coupled to the host-type device if it is determined that the at least one AV source, the at least one AV destination or a combination thereof, is not coupled to the signal path, the AV stream comprising at least one audio stream, at least one video stream, at least one voice stream, or a combination thereof.

14. The apparatus according to claim 13, wherein the processor is further capable of selecting a driver for the AV stream and selecting a priority table if it is determined that the at least one AV source, the at least one AV destination, or a combination thereof, is coupled to the AV path, and capable of processing the AV stream through the AV path based on priority information contained in the priority table, the priority information indicating a priority hierarchy of AV sources, AV destinations, or a combination thereof, for the AV stream.

15. The apparatus according to claim 14, wherein the processor is further capable of determining whether an AV source, an AV destination, or a combination thereof, has become uncoupled from the AV path while the AV stream is being processed, and determining an alternative AV source, AV destination, or a combination thereof, for the AV stream based on priority information contained in the priority table.

16. The apparatus according to claim 15, wherein the processing device comprises a dongle that is connectably coupled to the host-type device.

17. The apparatus according to claim 15, wherein the AV dongle is wirelessly coupled to the host device.

18. The apparatus according to claim 15, wherein at least one audio/video (AV) source, at least one AV destination, or a combination thereof, is connectably coupled to the AV dongle.

19. The apparatus according to claim 15, wherein at least one audio/video (AV) source, at least one AV destination, or a combination thereof, is wirelessly coupled to the AV dongle.

20. The apparatus according to claim 15, wherein the processing device is embedded as part of the host-type device.

21. The apparatus according to claim 15, wherein the host-type device comprises a desktop computer, a laptop computer, a cellular telephone, a smart phone, a television, a gaming device, a tablet-type device, an eReader-type device, or an ePad-type device.

22. The apparatus according to claim 13, wherein the apparatus comprises a dongle.
